(19) United States
(12) Patent Application Publication
(10) Pub. No.: US 2026/0320913 A1
(43) Pub. Date: Oct. 15, 2026

(54) INFORMATION PROCESSING SYSTEM, INFORMATION PROCESSING METHOD, AND PROGRAM

(71) Applicant: Sony Group Corporation, Tokyo (JP)

(72) Inventor: Kodai HATTORI, Kanagawa (JP)

(73) Assignee: Sony Group Corporation, Tokyo (JP)

(21) Appl. No.: 19/571,568

(22) Filed: Mar. 19, 2026

(30) Foreign Application Priority Data
Apr. 14, 2025 (JP) 2025-066026

(51) Int. Cl. G06T 17/00

(52) U.S. Cl. CPC G06T 17/00

(57) ABSTRACT

Provided is an information processing system. The information processing system includes a foreground-background model generating unit. The foreground-background model generates a foreground model which is a 3D model of a foreground, based on a foreground-background image obtained by capturing a foreground and a background from a plurality of viewpoints and a background model which is a 3D model of the background.

### CROSS-REFERENCE TO RELATED APPLICATION

This application claims the benefit of Japanese Priority Patent Application JP 2025-066026 filed Apr. 14, 2025, the entire contents of which are incorporated herein by reference.

### TECHNICAL FIELD

The present technology relates to an information processing system, an information processing method, and a program, and more particularly to an information processing system, an information processing method, and a program that are capable of separating a foreground and background in 3D and generate a 3D model of the foreground with high accuracy.

### BACKGROUND

There is a technique called volumetric capture (volumetric video) for generating free-viewpoint images of a subject (object), which are images from any virtual viewpoint in all directions of 360 degrees, from images captured from multiple viewpoints using a large number of cameras surrounding the subject.

In this volumetric capture, a modeling process is performed for generating a 3D (three-dimensional) model of a subject from captured images from multiple viewpoints, and the 3D model is rendered for virtual viewpoints to generate free-viewpoint images. An example of the modeling process includes a 2D (two-dimensional) separation modeling process in which the foreground area and background area in 2D images captured from each viewpoint are separated and a 3D model of the subject is generated from the 2D foreground areas from multiple viewpoints.

As a method of separating the foreground area and background area of a captured image, for example, there is a method of performing image-capturing in a capturing environment having a monochrome screen such as a green back or a blue back as the background and extracting areas of colors other than the color of the screen as the foreground area by chroma key processing.

In this method, the color of clothes, an object, or the like included in the subject is limited to colors different from the color of the screen. In addition, since it is necessary to surround the subject with a monochrome screen, color spill in which the color of the screen reflects onto the subject occurs in the captured image. When color spill or the like occurs, it is difficult to extract the subject as the foreground area with high accuracy by using chroma key processing. Consequently, a part of the subject may not be included in the foreground area, and thus a part of the 3D model of the subject may be missing, or the background may be included in the foreground area, and thus the color of the screen of the background is included in the free-viewpoint image generated based on the 3D model of the subject.

Another method of separating the foreground area and the background area is a background subtraction method of extracting the subject, as the foreground area, from the difference between a background image captured without the background and a foreground-background image captured with the background and the subject as the foreground. As a method of separating the foreground area and the background area, there is also an image segmentation method using deep learning or the like. However, in the background subtraction method and the image segmentation method, it is more difficult to extract the subject as the foreground area with high accuracy, compared to the method using the chroma key processing.

As a method of improving the accuracy in extraction of a foreground area, a method of integrating the separation results of the foreground area and the background area of the captured image of each viewpoint using a 3D model has been proposed (for example, refer to PTL 1). With this method, even if there is an occlusion in an image captured from multiple viewpoints, the foreground area can be appropriately extracted.

However, since the background subtraction method and the image segmentation method are a separation method in which results are integrated and a method used when separation is performed again based on the integrated separation result, the methods have a limitation in improving the accuracy in extraction of the foreground area.

As described above, the separation of the foreground area and background area in 2D is performed only in a single-viewpoint captured image, and thus it is difficult to perform the separation with high accuracy. In addition, projection errors also occur when generating a 3D model of the subject from foreground areas from multiple viewpoints. Thus, it is difficult to generate a 3D model of the subject with high accuracy using the 2D separation modeling process.

Meanwhile, a 3D modeling process has been proposed in which a 3D model of the foreground is learned, through machine learning, using foreground-background images from multiple viewpoints and background images and thereby the 3D model is generated as a 3D model of the subject (for example, see NPL 1).

In the 3D modeling process, a 3D model of the subject is directly generated. Therefore, compared to a case where a 3D model of the subject is generated from the 2D foreground areas from multiple viewpoints, the accuracy in separation of foreground areas does not affect the 3D model of the subject, and thus the 3D model of the subject can be generated with high accuracy.

Note that a 3D model by a neural radiance field (NeRF) is supplementarily added to the background images used in the 3D modeling process. Therefore, color information such as a shadow or the like that is not included in the background images but is included in the foreground-background images can be represented by the 3D model.

### CITATION LIST

### Patent Literature

PTL 1: JP 2020-160812 A
NPL 1: Lombardi, S., Simon, T., Schwartz, G., Zollhoefer, M., Sheikh, Y., & Saragih, J. “Mixture of volumetric primitives for efficient neural rendering” ACM Transactions on Graphics (ToG), Volume 40, Issu4, 2021. July 19, pp. 1-13

### SUMMARY

However, separating the foreground and background in 3D and generating a 3D model of the foreground as a 3D model of the subject with high accuracy has not been considered.

The present technology has been made in view of such circumstances, and an intention thereof is to enable separation of the foreground and background in 3D to generate a 3D model of the foreground with high accuracy.

According to one aspect of the present technology, an information processing system is an information processing system including a foreground model generating unit that generates a foreground model that is a 3D model of a foreground based on a foreground-background image obtained by capturing the foreground and a background from a plurality of viewpoints and a background model that is a 3D model of the background.

According to one aspect of the present technology, an information processing method is an information processing method including generating, by an information processing system, a foreground model that is a 3D model of a foreground, based on a foreground-background image obtained by capturing a foreground and a background from a plurality of viewpoints and a background model that is a 3D model of the background.

According to one aspect of the present technology, a program is a program for causing a computer to execute processing including generating a foreground model that is a 3D model of a foreground, based on a foreground-background image obtained by capturing a foreground and a background from a plurality of viewpoints and a background model that is a 3D model of the background.

According to one aspect of the present technology, a foreground model that is a 3D model of a foreground is generated based on a foreground-background image obtained by capturing a foreground and a background from a plurality of viewpoints and a background model that is a 3D model of the background.

The information processing system may be an independent device or may be a module incorporated in another device.

### BRIEF DESCRIPTION OF DRAWINGS

FIG. 1 is a block diagram illustrating an example of a configuration of a first embodiment of an information processing system.

FIG. 2 is a diagram illustrating an example of arrangement of image-capturing devices.

FIG. 3 is a block diagram illustrating an example of a configuration of a 3D model generating unit of FIG. 1.

FIG. 4 is a diagram illustrating examples of a background image and a foreground-background image.

FIG. 5 is a diagram illustrating an example of a foreground model.

FIG. 6 is a flowchart for describing a transmission process.

FIG. 7 is a flowchart for describing details of a foreground-background generation process.

FIG. 8 is a flowchart for describing a display process.

FIG. 9 is a block diagram illustrating an example of a configuration of a 3D model generating unit according to a second embodiment.

FIG. 10 is a diagram illustrating an example of a background image.

FIG. 11 is a block diagram illustrating an example of a configuration of a 3D model generating unit according to a third embodiment.

FIG. 12 is a block diagram illustrating an example of a configuration of hardware of a computer.

### DESCRIPTION OF EMBODIMENTS

Hereinafter, modes for carrying out the present technology (hereinafter, referred to as embodiments) will be described. The descriptions will be given in the following order.
1. First Embodiment (Information Processing System that Captures Background Image)
2. Second Embodiment (Information Processing System that Generates Background Image)
3. Third Embodiment (Information Processing System that Generates Background Model with Another Device)
4. Description of Computer to Which Present Technology is Applied
5. Application Example

### 1. First Embodiment

### Example of Configuration of Information Processing System

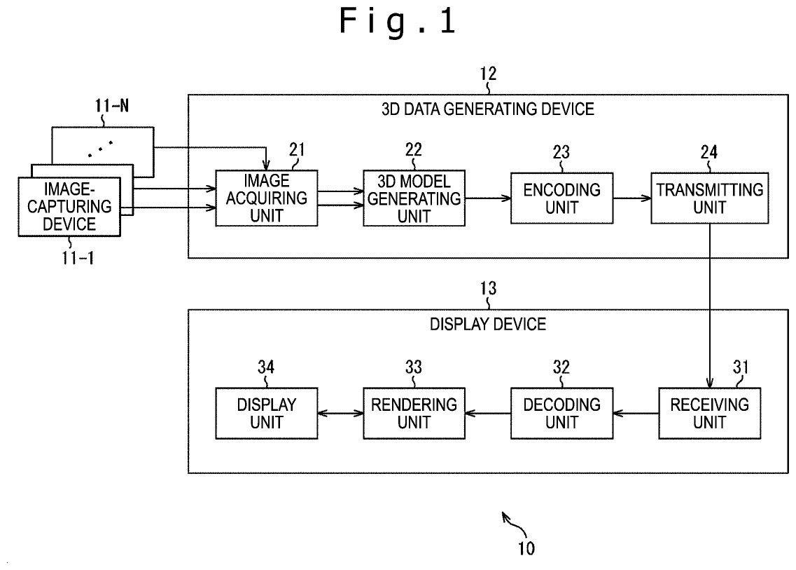

FIG. 1 is a block diagram illustrating an example of a configuration of a first embodiment of an information processing system to which the present technology is applied.

The information processing system 10 of FIG. 1 includes N (N is a plural number) image-capturing devices 11-1 to 11-N, a 3D data generating device 12, and a display device 13. The information processing system 10 generates a free-viewpoint image using N-viewpoint captured images obtained by the image-capturing devices 11-1 to 11-N, and displays the free-viewpoint image.

Specifically, the image-capturing devices 11-1 to 11-N are each arranged at different positions, and perform image-capturing in synchronization with each other. Each of the image-capturing devices 11-1 to 11-N captures only the background with no subject therein and supplies the resulting background image from N viewpoints to the 3D data generating device 12. Each of the image-capturing devices 11-1 to 11-N captures both a subject as a foreground and a background and supplies the resulting foreground-background images from N viewpoints to the 3D data generating device 12. Note that, the background images and the foreground-background images may be still images including images on a per-frame basis for a single frame or may be moving images including images on a per-frame basis for a plurality of frames.

Note that, hereinafter, when it is not necessary to distinguish the image-capturing devices 11-1 to 11-N from each other, they are collectively referred to as image-capturing devices 11. Capturing by the N image-capturing devices 11 may be virtually performed by physically moving one image-capturing device to each position of the N image-capturing devices 11 and capturing images. The N image-capturing devices 11 may be provided outside the information processing system 10.

The 3D data generating device 12 includes an image acquiring unit 21, a 3D model generating unit 22, an encoding unit 23, and a transmitting unit 24.

The image acquiring unit 21 acquires background images and foreground-background images from N viewpoints supplied from the N image-capturing devices 11. Note that, when there is no need to distinguish the background images from the foreground-background images herein below, they are collectively referred to as images for a 3D model.

The image acquiring unit 21 performs calibration based on the images for a 3D model from N viewpoints and obtains internal parameters and external parameters of respective image-capturing devices 11 as camera parameters. The image acquiring unit 21 supplies, to the 3D model generating unit 22, the images for a 3D model from N viewpoints and the camera parameters of the respective image-capturing devices 11 used when capturing the images for a 3D model from N viewpoints. Note that the image acquiring unit 21 may generate depth maps from respective multiple viewpoints based on the images for a 3D model from N viewpoints. A depth map from a certain viewpoint is an image in which a pixel value represents a depth value indicating the distance from the viewpoint to the subject.

The 3D model generating unit 22 generates, on a per-frame basis, a foreground model that represents a 3D model of the foreground and a background model that represents a 3D model of the background, based on the images for a 3D model from N viewpoints and the camera parameters supplied from the image acquiring unit 21.

Note that visual fidelity is important in separation of foreground models and background models. Thus, as a method of generating a foreground model and a background model, for example, 3D Gaussian Splatting (3DGS) or NeRF for generating a 3D model represented by using Radiance fields is used. The method of generating a foreground model and a background model may be a method of generating a 3D model that can be reproduced with visual fidelity, including a method of generating a 3D model represented in an expression method other than Radiance fields.

Here, in a case where the images for a 3D model from N viewpoints are still images, the generated foreground models and background models are foreground models and background models for a single frame, that is, foreground models and background models of still images. On the other hand, in a case where the images for a 3D model from N viewpoints are moving images, the generated foreground models and background models are foreground models and background models for multiple frames, that is, foreground models and background models of moving images. Since the foreground models and the background models are generated using the images for a 3D model, they are foreground models and background models of real images. The 3D model generating unit 22 supplies the generated foreground models to the encoding unit 23 as a 3D model of the subject.

The encoding unit 23 converts the 3D model of the subject supplied from the 3D model generating unit 22 into data in a format suitable for transmission or storage. For example, the encoding unit 23 performs rendering such as perspective projection on the 3D model of the subject from multiple viewpoints, thereby generating color images including pixel color information of each pixel from the multiple viewpoints and generating a depth map representing the distance from each of the multiple viewpoints to the 3D model. The encoding unit 23 encodes (compresses) the color images from the multiple viewpoints and the depth maps to generate transmission data.

At this time, the depth map and the color image from each viewpoint may be synthesized and encoded as one image, or may be encoded as separate images. Since the depth maps and the color images are 2D images, the depth maps and the color images can be encoded using an existing 2D image encoding technique such as Advanced Video Coding (AVC).

Note that the encoding unit 23 may convert the 3D model into 3D data in a point cloud format. In this case, the encoding unit 23 encodes the 3D data using a 3D compression technique of a geometry-based-approach discussed in the Moving Picture Experts Group (MPEG) and generates transmission data. The encoding unit 23 supplies the generated transmission data to the transmitting unit 24.

The transmitting unit 24 transmits the transmission data supplied from the encoding unit 23 to the display device 13.

In the 3D data generating device 12 configured as described above, the image acquiring unit 21, the 3D model generating unit 22, and the encoding unit 23 can perform processing offline in advance, and the transmitting unit 24 can transmit transmission data at a predetermined timing. The transmitting unit 24 may transmit the transmission data obtained as a result of processing performed by the image acquiring unit 21, the 3D model generating unit 22, and the encoding unit 23 in real time.

The display device 13 includes a receiving unit 31, a decoding unit 32, a rendering unit 33, and a display unit 34.

The receiving unit 31 receives the transmission data transmitted from the transmitting unit 24 and supplies the transmission data to the decoding unit 32.

The decoding unit 32 decodes the transmission data supplied from the receiving unit 31 to obtain depth maps and color images from multiple viewpoints. The decoding unit 32 generates a 3D Gaussian having information of, for example, position, size, rotation, color, and the like based on the depth maps and the color images from the multiple viewpoints and supplies the 3D Gaussian to the rendering unit 33.

The rendering unit 33 renders the 3D Gaussian supplied from the decoding unit 32 for a virtual viewpoint supplied from the display unit 34, thereby generating an image of the subject from the virtual viewpoint as a free-viewpoint image.

The display unit 34 is configured by a 2D monitor or a 3D monitor of a head-mounted display, a spatial display, a mobile telephone, a television receiver, a personal computer (hereinafter referred to as a “PC”), or the like. The display unit 34 performs display based on the free-viewpoint image supplied from the rendering unit 33.

The display unit 34 detects a viewing region (region of interest) of the user and determines, as a virtual viewpoint, a desired viewing viewpoint of the user in all directions of 360 degrees that are not related to the positions of the image-capturing devices 11, based on the viewing region. The display unit 34 supplies the virtual viewpoint to the rendering unit 33. Note that the display unit 34 may be provided outside the display device 13 or the information processing system 10.

Although the 3D data generating device 12 transmits the transmission data, and the display device 13 performs display based on the transmission data in the example of FIG. 1 as described above, the 3D data generating device 12 and the display device 13 may be integrated. In this case, since the information processing system 10 performs processing from the generation of foreground models and background models to the display of a free-viewpoint image with a single device such as a PC, there is no need to include the encoding unit 23, the transmitting unit 24, the receiving unit 31, and the decoding unit 32.

In a case in which the information processing system 10 is implemented, the whole may be implemented by one business operator or may be divided and implemented by a plurality of business operators. For example, in a case in which the information processing system 10 is divided and implemented by three business operators A to C, the business operator A implements the image acquiring unit 21, the 3D model generating unit 22, and the encoding unit 23 and generates transmission data. The business operator B implements the transmitting unit 24 and distributes the transmission data as a platformer. The business operator C generates a free-viewpoint image based on the transmission data by implementing the display device 13 and performs display based on the free-viewpoint image.

### Example of Arrangement of Image-Capturing Devices

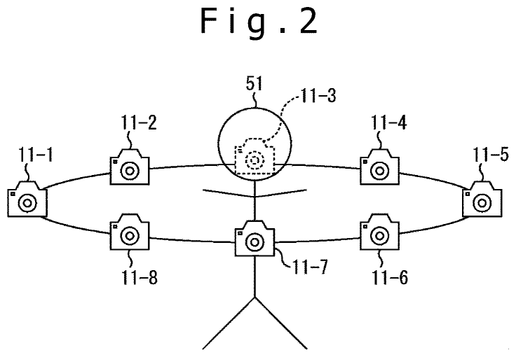

FIG. 2 is a diagram illustrating an example of arrangement of the image-capturing devices 11 of FIG. 1.

N is 8 in the example of FIG. 2. The image-capturing devices 11-1 to 11-8 are arranged to surround a subject 51 as illustrated in FIG. 2. Although the image-capturing devices 11 are arranged at equal intervals in the example of FIG. 2, the positions of the image-capturing devices 11 can be set to arbitrary positions.

### Example of Configuration of 3D Model Generating Unit

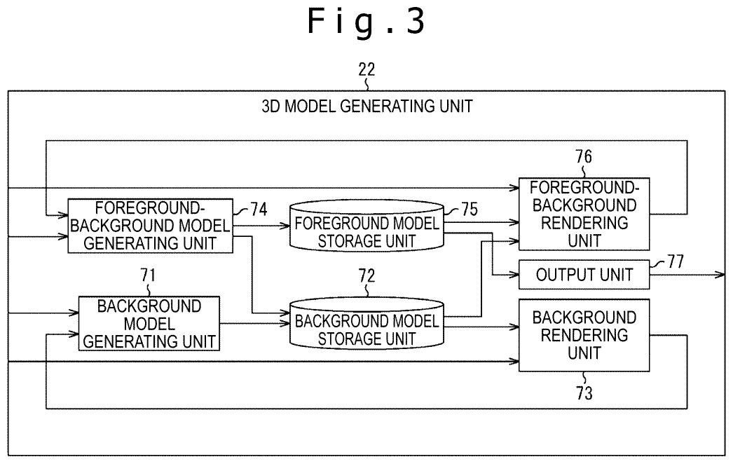

FIG. 3 is a block diagram illustrating an example of a configuration of the 3D model generating unit 22 of FIG. 1.

The 3D model generating unit 22 of FIG. 3 includes a background model generating unit 71, a background model storage unit 72, a background rendering unit 73, a foreground-background model generating unit 74, a foreground model storage unit 75, a foreground-background rendering unit 76, and an output unit 77.

Before a foreground-background generation process of generating a foreground model and updating a background model by the foreground-background model generating unit 74, the background model generating unit 71 sequentially sets each of the N viewpoints as a background target viewpoint that is a viewpoint as a target in the background model generation process. The background model generating unit 71 performs the generation process of generating a background model based on the background images from the N viewpoints supplied from the image acquiring unit 21 of FIG. 1 and a background rendering image that is a prediction value of a background image for a background target viewpoint supplied from the background rendering unit 73. The background model generating unit 71 supplies the resulting background model to the background model storage unit 72.

The background model storage unit 72 stores the background model. The background model storage unit 72 updates the background model already stored therein to the background model supplied from the background model generating unit 71 or the foreground-background model generating unit 74.

Accordingly, the background model already generated by the background model generating unit 71 is updated to the background model supplied from the foreground-background model generating unit 74. Thus, the background model may include subtle changes between the background image and the foreground-background image, such as shadows that are not included in the background image but are included in the foreground-background image.

The background rendering unit 73 reads the background model stored in the background model storage unit 72. The background rendering unit 73 generates a background rendering image for the background target viewpoint by rendering the background model for the background target viewpoint based on the camera parameters used when capturing the background image for the background target viewpoint supplied from the image acquiring unit 21. The background rendering unit 73 supplies the generated background rendering image to the background model generating unit 71.

The foreground-background model generating unit 74 sequentially sets each of the N viewpoints as a foreground-background target viewpoint which is a viewpoint as a target in the foreground-background generation process. The foreground-background model generating unit 74 (foreground model generating unit) performs the foreground-background generation process based on the foreground-background image for the foreground-background target viewpoint from the image acquiring unit 21 and the foreground-background rendering image which is a prediction value of the foreground-background image for the foreground-background target viewpoint from the foreground-background rendering unit 76. The foreground-background model generating unit 74 supplies the foreground model obtained as a result of the foreground-background generation process to the foreground model storage unit 75 and supplies the background model to the background model storage unit 72.

The foreground model storage unit 75 stores the foreground model. The foreground model storage unit 75 updates the foreground model already stored therein with the foreground model supplied from the foreground-background model generating unit 74.

The foreground-background rendering unit 76 reads the background model stored in the background model storage unit 72 and the foreground model stored in the foreground model storage unit 75. The foreground-background rendering unit 76 renders the background model and the foreground model for the foreground-background target viewpoint based on the camera parameters used when capturing the foreground-background image for the foreground-background target viewpoint supplied from the image acquiring unit 21. Accordingly, the foreground-background rendering unit 76 generates a foreground-background rendering image for the foreground-background target viewpoint. The background rendering unit 73 supplies the generated foreground-background rendering image to the foreground-background model generating unit 74.

The output unit 77 reads the foreground model from the foreground model storage unit 75 and outputs the foreground model to the encoding unit 23 of FIG. 1.

Examples of Background Image and Foreground-Background Image

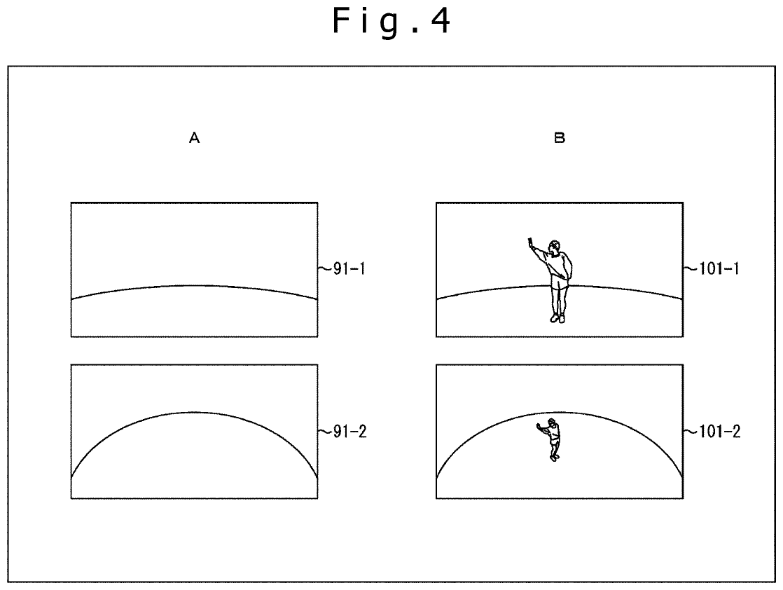

FIG. 4 is a diagram illustrating examples of the background image and the foreground-background image.

Specifically, A of FIG. 4 illustrates background images 91-1 and 91-2 from two viewpoints captured by two image-capturing devices 11, and B of FIG. 4 illustrates foreground-background images 101-1 and 101-2 from two viewpoints. Note that, in the examples of FIG. 4, although the background is a monochrome screen, the background is not limited thereto, and may be any capturing environment.

Note that, hereinafter, when there is no need to distinguish the background images 91-1 and 91-2, they are collectively referred to as background images 91. When there is no need to distinguish the foreground-background images 101-1 and 101-2 from each other, they are collectively referred to as foreground-background images 101.

### Example of Foreground Model

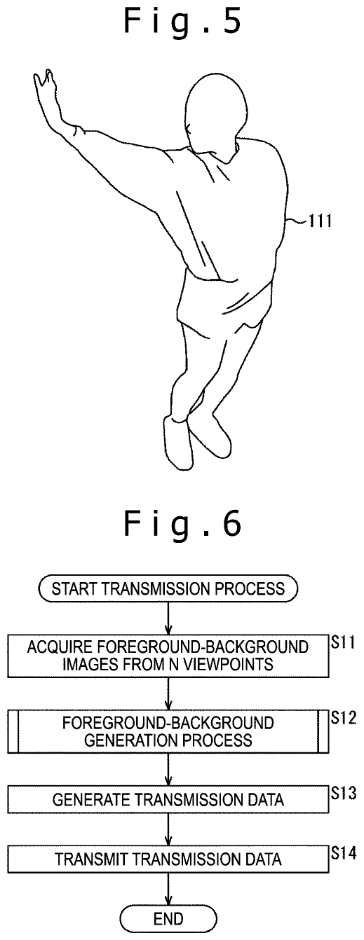

FIG. 5 is a diagram illustrating an example of the foreground model generated by the foreground-background model generating unit 74.

Note that, in the example of FIG. 5, the foreground-background model generating unit 74 performs the foreground-background generation process based on the background model generated using the background images 91 of FIG. 4 and the foreground-background images 101. In this case, a 3D model of the subject included as the foreground in the foreground-background images 101 is generated as a foreground model 111 as illustrated in FIG. 5.

### Description of Transmission Process

FIG. 6 is a flowchart describing a transmission process performed by the 3D data generating device 12 of FIG. 1. This transmission process is performed, for example, when the foreground-background images from N viewpoints on a per-frame basis are input from the N image-capturing devices 11, after the background model generation process has been completed.

In step S11 of FIG. 6, the image acquiring unit 21 acquires foreground-background images from N viewpoints supplied from the N image-capturing devices 11. The image acquiring unit 21 performs calibration based on the foreground-background images from N viewpoints and acquires camera parameters. The image acquiring unit 21 supplies the foreground-background images from the N viewpoints and the camera parameters to the 3D model generating unit 22.

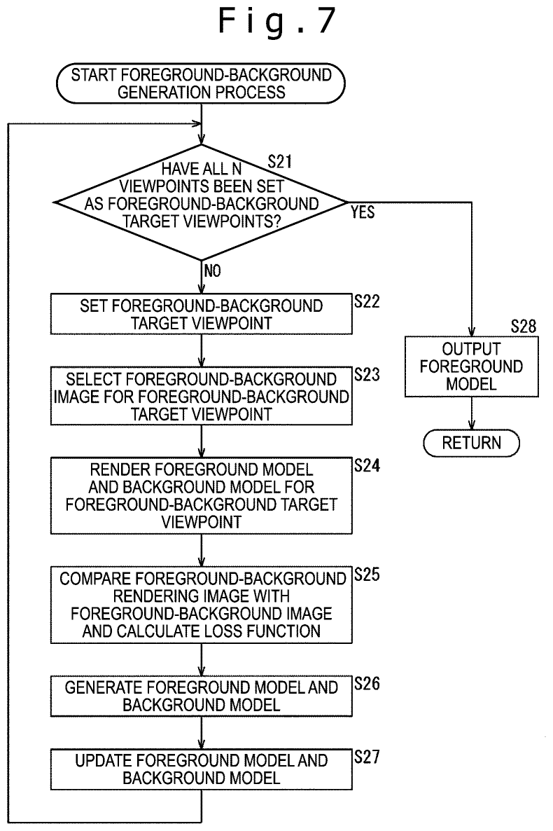

In step S12, the 3D model generating unit 22 performs the foreground-background generation process based on the foreground-background images from N viewpoints and the camera parameters supplied from the image acquiring unit 21. The foreground-background generation process will be described with reference to FIG. 7 described below in detail.

In step S13, the encoding unit 23 converts the format of the 3D model of the subject obtained in the processing of step S12 and generates transmission data. The encoding unit 23 supplies the generated transmission data to the transmitting unit 24.

In step S14, the transmitting unit 24 transmits the transmission data generated by the processing of step S13 to the display device 13. Thereby the transmission process ends.

### Description of Foreground-Background Generation Process

FIG. 7 is a flowchart for describing details of the foreground-background generation process of step S12 of FIG. 6.

In step S21 of FIG. 7, the foreground-background model generating unit 74 determines whether all the N viewpoints have been set as the foreground-background target viewpoint. If it is determined in step S21 that all the N viewpoints have not been set as the foreground-background target viewpoint, the process proceeds to step S22.

In step S22, the foreground-background model generating unit 74 sets, as a foreground-background target viewpoint, a viewpoint among the N viewpoints that has not been set as a foreground-background target viewpoint. In step S23, the foreground-background model generating unit 74 selects, as data for generation, a foreground-background image of the foreground-background target viewpoint from the foreground-background images from the N viewpoints supplied from the image acquiring unit 21.

In step S24, the foreground-background rendering unit 76 renders the foreground model stored in the foreground model storage unit 75 and the background model stored in the background model storage unit 72 for the foreground-background target viewpoint based on the camera parameters of the foreground-background target viewpoint. The foreground-background rendering unit 76 supplies the resulting foreground-background rendering image for the foreground-background target viewpoint to the foreground-background model generating unit 74.

In step S25, the foreground-background model generating unit 74 compares the foreground-background rendering image generated in step S24 with the foreground-background image for the foreground-background target viewpoint selected in step S23 and calculates a loss function.

In step S26, the foreground-background model generating unit 74 generates a foreground model and a background model based on the loss function calculated in step S25. Specifically, the foreground-background model generating unit 74 optimizes the parameters of the foreground model and the background model so that the foreground-background rendering image approaches the foreground-background image based on the loss function.

In step S27, the foreground-background model generating unit 74 supplies the foreground model generated in step S26 to the foreground model storage unit 75, thereby updating the foreground model. The foreground-background model generating unit 74 supplies the background model generated in step S26 to the background model storage unit 72, thereby updating the background model. After the processing of step S27, the process returns to step S21, and the subsequent processing is repeated until all the N viewpoints are set as the foreground-background target viewpoint.

On the other hand, if it is determined in step S21 that all the N viewpoints have been set as the foreground-background target viewpoint, the process proceeds to step S28. In step S28, the output unit 77 outputs the foreground model stored in the foreground model storage unit 75 to the encoding unit 23 of FIG. 1. Then, the foreground-background generation process ends, and the process returns to step S12 of FIG. 5 and proceeds to step S13.

Note that the background model generation process by the background model generating unit 71 is similar to the foreground-background generation process except that a foreground-background target viewpoint is replaced with a background target viewpoint, a foreground-background image is replaced with a background image, and a foreground model and a background model are replaced with only a background model.

### Description of Display Process

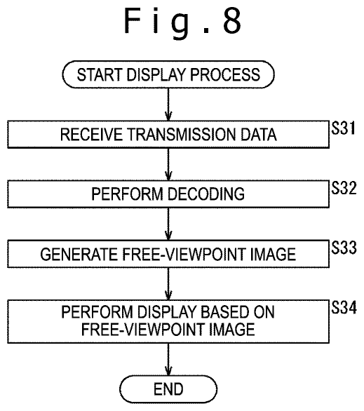

FIG. 8 is a flowchart for describing a display process by the display device 13 of FIG. 1. The display process is started, for example, when the transmission data is transmitted in the processing of step S14 of FIG. 6.

In step S31 of FIG. 8, the receiving unit 31 receives the transmission data transmitted through the processing of step S14 of FIG. 6 and supplies the transmission data to the decoding unit 32.

In step S32, the decoding unit 32 decodes the transmission data received in the processing of step S31 and obtains depth maps and color images from multiple viewpoints. The decoding unit 32 generates a 3D Gaussian based on the depth maps and the color images from the multiple viewpoints and supplies the 3D Gaussian to the rendering unit 33.

In step S33, the rendering unit 33 renders the 3D Gaussian supplied from the decoding unit 32 for a virtual viewpoint supplied from the display unit 34, thereby generating a free-viewpoint image. The rendering unit 33 supplies the free-viewpoint image to the display unit 34.

In step S34, the display unit 34 performs display based on the free-viewpoint image generated in the processing of step S33. Thereby the display process ends.

As described above, in the information processing system 10, the foreground-background model generating unit 74 generates a foreground model based on the foreground-background images from N viewpoints and the background model. Accordingly, the foreground and the background can be separated in 3D, and the foreground model can be generated with high accuracy. In addition, compared to a method of extracting a foreground area from a captured image from each viewpoint using chroma key processing and generating a foreground model from the foreground area, it is not necessary to install a monochrome screen or limit a subject, and thus it is possible to simplify the capturing environments.

The background model is generated and updated separately from the foreground model when the foreground model is generated. Accordingly, a shadow or the like that is not included in the background image and thus is not included in the background model before the foreground-background generation process but is included in the foreground-background image can be included in the background model when the foreground model is generated. As a result, the foreground and the background in 3D can be separated with higher accuracy.

Note that the background model generated by the background model generating unit 71 may be corrected before the foreground-background generation process. This correction is made based on, for example, an instruction from the user or prior information regarding the capturing environment such as background depth information indicating the distances from the image-capturing devices 11 to the background. This makes it possible to improve the accuracy of the background model and generate the foreground model with higher accuracy. The background depth information is input by the user or measured with a range-finding device or the like installed in the image-capturing devices 11, for example.

### 2. Second Embodiment

### Example of Configuration of 3D Model Generating Unit

The configuration of a second embodiment of the information processing system to which the present technology is applied differs from the information processing system 10 of FIG. 1 in that the image-capturing device 11 does not capture background images, the image acquiring unit 21 does not acquire camera parameters of the background images, and the 3D model generating unit is configured differently. The other configurations are the same as those of the information processing system 10. Therefore, the following description will be provided focusing on the 3D model generating unit.

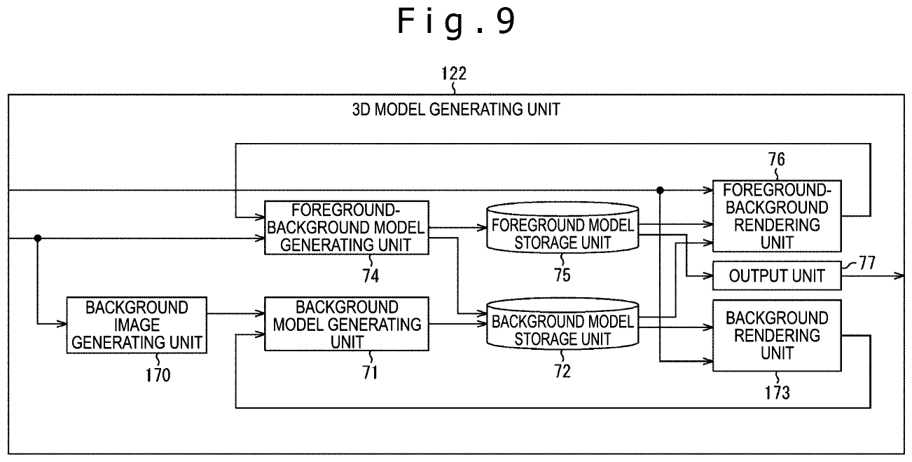

FIG. 9 is a block diagram illustrating an example of a configuration of the 3D model generating unit according to the second embodiment of the information processing system to which the present technology is applied.

For the 3D model generating unit 122 of FIG. 9, the same reference numerals are given to the portions corresponding to those of the 3D model generating unit 22 of FIG. 3. Thus, the description on those portions is omitted as appropriate, and the portions different from those of the 3D model generating unit 22 will be mainly described. The 3D model generating unit 122 differs from the 3D model generating unit 22 in that a background image generating unit 170 is newly provided and a background rendering unit 173 is provided instead of the background rendering unit 73, but is configured similarly to the 3D model generating unit 22 in other configurations. The 3D model generating unit 122 generates background images from N viewpoints from foreground-background images from N viewpoints.

Specifically, a foreground-background image is supplied from the image acquiring unit 21 to the background image generating unit 170. The background image generating unit 170 extracts a foreground area from the foreground-background image. As the extraction method, the above-described chroma key processing method, image segmentation method, or the like can be used. Since the foreground area is extracted to generate a background image used for generating the initial background model from the foreground-background image, the extraction does not need to be performed with high accuracy.

The background image generating unit 170 sets a pixel value of the foreground area of the foreground-background image to 0, thereby generating, as a background image, the foreground-background image with the foreground area masked. The background image generating unit 170 supplies the generated background image to the background model generating unit 71.

Camera parameters used when capturing foreground-background images from N viewpoints are supplied to the background rendering unit 173 from the image acquiring unit 21. The background rendering unit 173 reads background models stored in the background model storage unit 72. The background rendering unit 173 generates a background rendering image for the background target viewpoint based on the camera parameters used when capturing foreground-background images for the background target viewpoint, similarly to the background rendering unit 73. The background rendering unit 173 supplies the generated background rendering image to the background model generating unit 71.

### Example of Background Image

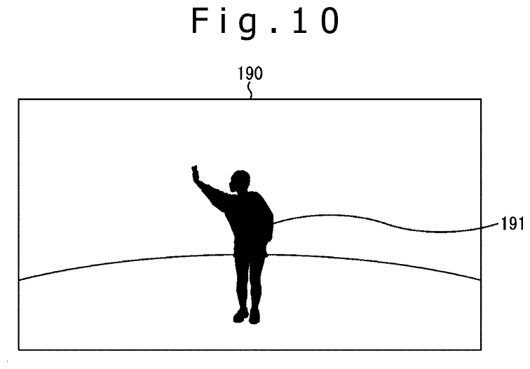

FIG. 10 is a diagram illustrating an example of a background image for a predetermined viewpoint generated by the background image generating unit 170 of FIG. 9.

The background image 190 is an image with the foreground area 191 masked by setting the pixel value of the foreground area 191 of the foreground-background image to 0 as illustrated in FIG. 10.

Since the 3D model generating unit 122 generates a background image from a foreground-background image as described above, the image-capturing device 11 may capture only foreground-background images. Therefore, in the second embodiment of the information processing system, a foreground model can be generated more easily.

Note that, in the first embodiment and the second embodiment, a viewpoint of either a foreground-background image or a background image may be one of N viewpoints.

### 3. Third Embodiment

### Example of Configuration of 3D Model Generating Unit

In a third embodiment of the information processing system to which the present technology is applied, the configuration of the 3D model generating unit differs from that of the information processing system 10 of FIG. 1, and the other configurations are the same as those of the information processing system 10. Therefore, the following description will be provided focusing on the 3D model generating unit.

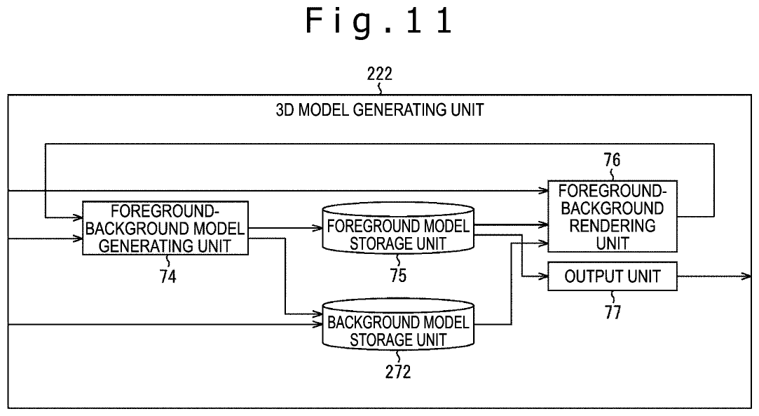

FIG. 11 is a block diagram illustrating an example of a configuration of the 3D model generating unit according to the third embodiment of the information processing system to which the present technology is applied.

For the 3D model generating unit 222 of FIG. 11, the same reference numerals are given to the portions corresponding to those of the 3D model generating unit 22 of FIG. 3. Thus, the description on those portions is omitted as appropriate, and the portions different from those of the 3D model generating unit 22 will be mainly described. The 3D model generating unit 222 differs from the 3D model generating unit 22 in that the background model generating unit 71 and the background rendering unit 73 are not provided and that a background model storage unit 272 is provided instead of the background model storage unit 72. The other components are configured in the same manner as the 3D model generating unit 22. The 3D model generating unit 222 acquires a background model generated by an external device, which is not illustrated.

Specifically, the background model storage unit 272 is supplied with a background model generated by an external device, which is not illustrated, before the foreground-background generation process. The background model storage unit 272 stores the background model. The background model storage unit 272 updates the background model already stored therein with the background model supplied from the foreground-background model generating unit 74.

Although the external device generates a background model in the same manner as the background model generating unit 71 of FIG. 3, for example, the N viewpoints corresponding to the background images used for generating the background model may be the same as the N viewpoints corresponding to the foreground-background images, or may differ at least in part. For example, the external device may generate a highly accurate background model using a background image captured from a position closer to the background than the capturing positions of the foreground-background images. The number of viewpoints of the background image may be the same as or different from the number of viewpoints N of the foreground-background images.

Since the 3D model generating unit 222 retains background information as a background model as described above, a background image from a certain viewpoint is not necessary for generation of a foreground-background rendering image from the viewpoint. As a result, the flexibility of the background model generation process is increased. In contrast, in a case in which background information is retained as a background image, a background image from a certain viewpoint is necessary for generation of a foreground-background rendering image from the viewpoint.

The external device may generate a highly accurate background model using information that is not used in the foreground-background generation process, such as depth information detected by a depth sensor or the like. The background model generated by the external device may be corrected before the foreground-background generation process, similarly to the background model generated by the background model generating unit 71.

### 4. Description of Computer to Which Present Technology is Applied

The above-described series of processing operations can be executed by hardware or can be executed by software. When the series of processing operations is performed by software, a program constituting the software is installed on a computer. Herein, a computer includes a computer incorporated in dedicated hardware, a general-purpose personal computer, for example, that can execute various functions by the installation of various programs, and the like.

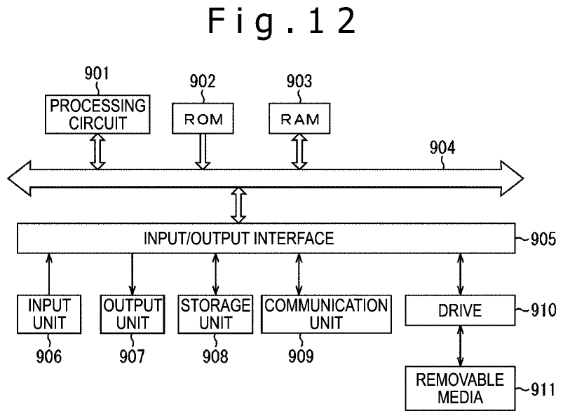

FIG. 12 is a block diagram illustrating a configuration example of hardware of a computer that executes the above-described series of processing operations using a program.

In the computer, a processing circuit 901, a read only memory (ROM) 902, and a random access memory (RAM) 903 are connected to one another via a bus 904.

An input/output interface 905 is also connected to the bus 904. The input/output interface 905 is connected to an input unit 906, an output unit 907, a storage unit 908, a communication unit 909, and a drive 910.

The input unit 906 can include a physical or virtual operation means for inputting information by a user's operation, such as a keyboard, a mouse, or a touch panel, input terminals, and a means for inputting information by a user by using voices, lines of sight, or the like. Further, the input unit 906 can include sensors for inputting various physical quantities to the computer. For example, the input unit 906 can include sensors that acquire physical quantities of light (including infrared rays other than visible light), sound, or the like, such as a camera or a microphone. In addition, for example, the input unit 906 can include sensors that acquire other physical quantities such as temperature, moisture content, acceleration, and distance. The output unit 907 can include a means for presenting information to the user by stimulating the user's perception, such as a display, a speaker, or a haptic device and output terminals. The storage unit 908 is configured by a hard disk, a RAM disk, a nonvolatile or volatile memory, or the like, and stores various types of information (including programs). The communication unit 909 is a network interface or the like, and performs wired or wireless communication with the outside. The drive 910 drives a removable medium 911 such as a magnetic disk, an optical disc, a magneto-optical disc, or a semiconductor memory.

The processing circuit 901 includes a processor that executes a program, such as a central processing unit (CPU) or a digital signal processor (DSP). The (processor of the) processing circuit 901 loads a program stored in the storage unit 908 into the RAM 903 via the input/output interface 905 and the bus 904, and executes the program, thereby performing the above-mentioned series of processing operations. The processing circuit 901 can cause the output unit 907 to output the processing result of the series of processing operations, for example, via the bus 904 and the input/output interface 905, if necessary. The processing circuit 901 can also cause the storage unit 908 to store the processing result, cause the communication unit 909 to transmit the processing result, and the like. The RAM 903 also appropriately stores data necessary for the processing circuit 901 to perform various processing operations.

A program executed by the computer (processing circuit 901) can be provided by being recorded in the removable medium 911 as a package medium or the like, for example. Further, the program can be provided via a wired or wireless transmission medium, such as a local area network, the Internet, or digital satellite broadcasting.

In the computer, the program can be installed in the storage unit 908 via the input/output interface 905 by mounting the removable medium 911 on the drive 910. Further, the program can be received by the communication unit 909 from another device such as a server via a wired or wireless transmission medium, such as a local area network, the Internet, or digital satellite broadcasting and installed in the storage unit 908. In addition, the program can be installed in advance in the ROM 902 or the storage unit 908.

The program executed by the computer may be a program in which processing is performed in a time-series manner in the order described in the present specification, or may be a program in which processing is performed in parallel or at a necessary timing such as a time when a call is made.

The processing performed by the computer according to the program does not have to be performed in time series in the order described as the flowchart. That is, the processing performed by the computer according to the program includes processing executed in parallel or in an individual manner (for example, parallel processing or processing by an object).

The program may be processed by one computer (processor) or may be processed in a distributed manner by a plurality of computers. Further, the program may be transferred to a remote computer and executed.

In a case in which the series of processing operations described above is performed by the computer executing the program, the input unit 906 functions as the image-capturing device 11. The storage unit 908 functions as the background model storage unit 72 and the foreground model storage unit 75. The (processor of the) processing circuit 901 executes the program to function as the 3D data generating device 12 other than the background model storage unit 72 (272) and the foreground model storage unit 75, and the display device 13 other than the display unit 34. The output unit 907 functions as the display unit 34.

### 5. Application Example

### Application to Production of Video Content

The technology according to the present disclosure can be applied to various kinds of products and services.

For example, a new video content may be produced by combining a 3D model of a subject generated according to the present embodiment and a 3D model managed by another server. In addition, for example, by combining a background image captured by an image-capturing device such as a Lidar and a 3D model of a subject generated according to the present embodiment, a video content in which the subject seems to be present at the place indicated by the background image can be produced.

Note that a 3D model of a subject generated according to the present embodiment is, for example, a 3D model of the subject generated by the 3D model generating unit 22 (122 or 222). A produced video content may be a three-dimensional video content or a two-dimensional video content obtained through two-dimensional conversion.

### Application to Experience in Virtual Space

For example, in a virtual space in which a user performs communication through an avatar, a subject corresponding to the 3D model of the subject generated according to the present embodiment can be arranged as, for example, a performer. In this case, the user can view the actually captured subject in the virtual space as an avatar.

Application to Communication with Remote Location

For example, the transmitting unit 24 transmits transmission data of a 3D model of a subject generated by the 3D model generating unit 22 (122 or 222) to the display device 13 at a remote location to enable a user at the remote location to view the 3D model of the subject through the display device 13. For example, the transmitting unit 24 transmits the transmission data of the 3D model of the subject in real time, thereby enabling the subject and the user at the remote location to communicate with each other in real time. As such communication, for example, communication between a subject who is a teacher and a user who is a student, or communication between a subject who is a doctor and a user who is a patient is assumed.

### Others

For example, free-viewpoint images of sports games or the like can be generated based on 3D models of a plurality of subjects generated according to the present embodiment, and a person can distribute his/her own 3D model generated according to the present embodiment in a distribution platform.

In the present specification, a system means one component or a set of a plurality of components (device, modules (parts), and the like). Accordingly, one or a plurality of components of a computer, for example, only a processor or a combination of a processor and a memory (e.g., only the processing circuit 901 or a combination of the processing circuit 901 through the bus 904), is a system. With respect to a set of a plurality of components, it does not matter whether all the components are in the same housing or not. Therefore, the system refers to both a plurality of devices housed in separate housings and connected via a network, and one device in which a plurality of modules are housed in one housing. Furthermore, for example, the entire computer, or a combination of a computer and another device such as a server (not illustrated) is also a system.

The components (blocks) of the devices described in the present specification and illustrated in the drawings are functional conceptual blocks, and an actual device does not need to have the illustrated configuration. In other words, the devices may have any configuration in which the functions of the illustrated components are divided and/or integrated in any unit, for example, a configuration having one block in which the functions of all the components are integrated.

The embodiments of the present technology are not limited to the above-described embodiments, and various modifications can be made without departing from the gist of the present technology.

For example, a mode in which all or some of the plurality of embodiments described above are combined can be adopted.

For example, the present technology can have a configuration of cloud computing in which one function is distributed and processed in cooperation by a plurality of devices via a network. For example, the rendering unit 33 may be implemented by a server outside the display device 13. In this case, information is exchanged between the display device 13 and the server.

Further, each step described in the above-described flowchart can be performed by one device or can be shared and executed by a plurality of devices.

Further, when a single step includes multiple processes, the multiple processes included in that single step can be executed by a single device, or can be shared and executed by multiple devices.

The effects described in the present specification are mere examples and are not limiting. There may be other effects.

The present technology may also adopt configurations as described below.
(1)

An information processing system including
a foreground model generating unit that generates a foreground model that is a 3D model of a foreground, based on a foreground-background image obtained by capturing a foreground and a background from a plurality of viewpoints and a background model that is a 3D model of the background.
(2)

The information processing system described in (1), in which the foreground model generating unit generates the foreground model based on the foreground-background image and the background model, and updates the background model.
(3)

The information processing system described in (1) or (2), in which the foreground model generating unit generates the foreground model also based on a camera parameter used when capturing the foreground-background image.
(4)

The information processing system described in any one of (1) to (3), further including
a background model generating unit that generates the background model based on background images from a plurality of viewpoints,
in which the foreground model generating unit generates the foreground model based on the foreground-background image and the background model generated by the background model generating unit.
(5)

The information processing system described in (4), in which the background model generating unit generates the background model also based on a camera parameter used when capturing the background image.
(6)

The information processing system described in (5), in which the background image is captured by an image-capturing device.
(7)

The information processing system described in (6), in which the plurality of viewpoints corresponding to the background image are different from at least some of the plurality of viewpoints corresponding to the foreground-background image.
(8)

The information processing system described in (6), in which the foreground-background image is captured by the image-capturing device.
(9)

The information processing system described in (5), further including
a generating unit that generates the background image from the foreground-background image,
in which the background model generating unit generates the background model based on the background image generated by the generating unit.
(10)

The information processing system described in any one of (1) to (9), further including
an output unit that outputs the foreground model generated by the foreground model generating unit.
(11)

The information processing system described in any one of (1) to (10), in which the foreground model generating unit generates the foreground model by using a method of generating a 3D model represented by using Radiance fields, based on the foreground-background image and the background model.
(12)

The information processing system described in any one of (1) to (11), in which the foreground model generating unit generates the foreground model by using 3D Gaussian Splatting, based on the foreground-background image and the background model.
(13)

The information processing system described in any one of (1) to (11), in which the foreground model generating unit generates the foreground model by using NeRF, based on the foreground-background image and the background model.
(14)

An information processing method including
generating, by an information processing system, a foreground model that is a 3D model of a foreground, based on a foreground-background image obtained by capturing a foreground and a background from a plurality of viewpoints and a background model that is a 3D model of the background.
(15)

A program for causing a computer to execute processing including
generating a foreground model that is a 3D model of a foreground, based on a foreground-background image obtained by capturing a foreground and a background from a plurality of viewpoints and a background model that is a 3D model of the background.
(16)

The program described in (15), in which the background model is generated before the foreground model is generated.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

10 Information processing system, 11-1 to 11-N Image-capturing device, 71 Background model generating unit, 74 Foreground-background model generating unit, 77 Output unit, 91-1,91-2 Background image, 101-1,101-2 Foreground-background image, 111 Foreground model, 170 Background image generating unit

1. An information processing system, comprising
a foreground model generating unit configured to generate a foreground model that is a 3D model of a foreground, based on a foreground-background image obtained by capturing a foreground and a background from a plurality of viewpoints and a background model that is a 3D model of the background.

2. The information processing system according to claim 1, wherein the foreground model generating unit generates the foreground model based on the foreground-background image and the background model, and updates the background model.

3. The information processing system according to claim 1, wherein the foreground model generating unit generates the foreground model also based on a camera parameter used when capturing the foreground-background image.

4. The information processing system according to claim 1, further comprising
a background model generating unit configured to generate the background model based on background images from a plurality of viewpoints,
wherein the foreground model generating unit generates the foreground model based on the foreground-background image and the background model generated by the background model generating unit.

5. The information processing system according to claim 4, wherein the background model generating unit generates the background model also based on a camera parameter used when capturing the background image.

6. The information processing system according to claim 5, wherein the background image is captured by an image-capturing device.

7. The information processing system according to claim 6, wherein the plurality of viewpoints corresponding to the background image are different from at least some of the plurality of viewpoints corresponding to the foreground-background image.

8. The information processing system according to claim 6, wherein the foreground-background image is captured by the image-capturing device.

9. The information processing system according to claim 5, further comprising a generating unit configured to generate the background image from the foreground-background image,
wherein the background model generating unit generates the background model based on the background image generated by the generating unit.

10. The information processing system according to claim 1, further comprising
an output unit configured to output the foreground model generated by the foreground model generating unit.

11. The information processing system according to claim 1, wherein the foreground model generating unit generates the foreground model by using a method of generating a 3D model represented by using Radiance fields, based on the foreground-background image and the background model.

12. The information processing system according to claim 1, wherein the foreground model generating unit generates the foreground model by using 3D Gaussian Splatting, based on the foreground-background image and the background model.

13. The information processing system according to claim 1, wherein the foreground model generating unit generates the foreground model by using NeRF, based on the foreground-background image and the background model.

14. An information processing method comprising
generating, by an information processing system, a foreground model that is a 3D model of a foreground, based on a foreground-background image obtained by capturing a foreground and a background from a plurality of viewpoints and a background model that is a 3D model of the background.

15. A program for causing a computer to execute processing comprising
generating a foreground model that is a 3D model of a foreground, based on a foreground-background image obtained by capturing a foreground and a background from a plurality of viewpoints and a background model that is a 3D model of the background.

16. The program according to claim 15, wherein the background model is generated before the foreground model is generated.
